(19) United States
(12) Patent Application Publication
(10) Pub. No.: US 2011/0289758 A1
(43) Pub. Date: Dec. 1, 2011

(54) SLAT AND COVERING METHOD

(76) Inventor: HAN-SEN LEE, Chang-Hwa Hsien (TW)

(21) Appl. No.: 13/206,519

(22) Filed: Aug. 10, 2011

Related U.S. Application Data
(62) Division of application No. 11/799,492, filed on Apr. 30, 2007.

(51) Int. Cl. B23P 11/00

(52) U.S. Cl. 29/428

(57) ABSTRACT

The present invention includes both the structures and process for producing an economical slat which has the appearance of a single length of high-quality wood. A support structure may be a single length of material or may be pieced together using multiple short lengths. The support structure is veneered on two sides using any commonly acceptable adhesive. The partially veneered support structure is then sliced to form one or more individual slats having veneered longitudinal edges. The veneered edges may be sanded to a radius before or after fully enclosing the support structure by applying additional veneer to the sides of the slats. A clear and appropriate finish varnish, preferably of ultraviolet-resistant material, may be applied as a finishing measure.

### FIELD OF THE INVENTION

The present invention relates to a slat and method for producing a slat which is conservative of materials and natural resources, and which utilizes veneer to achieve the appearance of a single length of high-quality wood having radiused leading and trailing edges for an aesthetically pleasing look commonly desirable in slats used in louvered window coverings.

### BACKGROUND OF THE INVENTION

Slats may be utilized in a variety of louvered window coverings, including Venetian blinds and vertical blinds. To conserve both materials and natural resources, natural wood slats may be constructed of a wood which may be both plentiful and inexpensive. Often, however, less expensive and readily available types of wood may be soft, may not easily accept stain, or may stain or sand unevenly.

Consequently, it may be desirable to apply a veneer to a slat to create an aesthetically pleasing appearance. Where a veneer has a brittle quality, such as genuine wood veneer made from a thin layer of potentially expensive, high-quality wood superior to that from which the slat is constructed, a square-edged slat may cause breakage of the veneer as it is being applied around any of the 4 corners of the slat. Breakage of veneer results in waste, which may be quite costly, especially in quantity.

Slats with radiused leading and trailing edges are a popular option in blind sets because of their more modern appeal. However, slats made from the less expensive woods described above may sand unevenly where the wood is soft, or may splinter or crumble upon sanding if the wood is friable. This may result in wasting expensive materials, and may also be problematic where a stained-wood slat is desired as staining may not camouflage unattractive wood or uneven texture that may result from sanding. Although veneering with materials other than wood is an option, thin veneers, such as paper veneers, are likely to cleave to any sanding defects to produce an unattractive dimpled surface in the finished product. Moreover, veneers that simulate a wood grain are usually easily detectable as such and are thus poor substitutes for genuine wood slats.

To conserve valuable resources, natural wood slats may be formed by piecing together short lengths of scrap wood. This technique may be advantageous for avoiding waste or decreasing the possibility of warping. Sanding pieced-together slats to round the leading and trailing edges, however, is generally not practicable because each segment will usually differ from its neighboring segment in grade, grain, or hardness. Staining the slats is also not likely to be a viable option because stain is usually not adequately opaque to hide the joints or the differing grades and grains of wood. In addition to being obvious, thin veneers, such as paper, may also be ineffective where sanding defects are present because of the potential dimpling effect described above.

Finally, slats may be constructed of manmade materials in either single or pieced lengths. Where the material from which the slats are constructed is not aesthetically pleasing, or where a user desires a particular high-end look, such as a wood look, without the associated high costs, few options may be available. A user may paint the slats to achieve a faux-wood finish, for example, but this option is generally costly, time consuming, and may yield fake-looking results at best. Genuine wood veneer may be applied to achieve a wood look, but where the slat is square-edged, similar problems as those discussed above may result. Where a square-edged slat is constructed of any material which is not conducive to sanding, rounded leading and trailing edges may not be easily achievable.

What is needed is a slat and method which conserves costly materials by enabling a high-quality veneer to be easily and economically applied to an inexpensive underlayment to achieve smoothly radiused leading and trailing edges for an aesthetically pleasing look commonly desirable in louvered blinds.

### SUMMARY OF THE INVENTION

The structures and process for producing the slat of the present invention enable easy and economical application of an aesthetically pleasing, high-end, high quality veneer to a support structure which may be a single length of wood scrap or other low-cost material, or which may be pieced together from a plurality of short lengths of wood scrap or low-cost material. Because the support structure is optimally constructed either from readily available and/or inexpensive materials such as recovered scrap, and because the potentially costly, high-grade veneer is applied sparingly to cover the support structure, the invention is helpful in conserving natural resources.

The support structure may be sandwiched between two layers of high-grade veneer which may then be glued to the support structure using any commonly acceptable adhesive. The resulting partially veneered support structure may then be sliced by cutting through both sheets of veneer and through the support structure to form partially veneered individual slats for which the existing veneer will become the leading and trailing edges. The leading and trailing edges on each slat may then be radiused by sanding or by using any other equally effective method. The slat may be further veneered to fully enclose the support structure either before or after sanding.

Where the slats are completely veneered prior to sanding, the additional layers of veneer applied to each slat should optimally be of a length which minimizes waste during sanding. Completely veneering each slat prior to sanding, however, may result in a smoother and less visible transition between the four pieces of veneer and may require less overall sanding effort to finish. A clear and appropriate surface varnish, preferably of ultraviolet-resistant material, may be applied to the veneered slat for protection and for creating a finished look.

### BRIEF DESCRIPTION OF THE DRAWINGS

The invention, its configuration, construction, and operation will be best further described in the following detailed description, taken in conjunction with the accompanying drawings in which:

FIG. 1 is a perspective view of a support structure which may be a single length of material or which may be pieced together using several short lengths of material as shown;

FIG. 2 is a perspective view of the support structure of FIG. 1 and further includes a layer of veneer applied to each of two longitudinal main surfaces of the support structure;

FIG. 3 is a perspective view of the veneered support structure of FIG. 2 and further includes a cutting tool which is shown slicing through the support structure and through both layers of veneer to isolate a partially veneered slat;

FIG. 4 is an cross-sectional view of the isolated and partially veneered slat of FIG. 3;

FIG. 5 is a cross-sectional view of the slat of FIG. 4 and further includes a layer of veneer applied to each of two longitudinal main surfaces of the slat;

FIG. 6 is a cross-sectional view of a partially veneered slat which has been sanded prior to having a layer of veneer applied to each of its two longitudinal main surfaces; and

FIG. 7 is a cross-sectional view of a fully veneered and sanded slat, and further includes a layer of surface varnish thereon.

### DETAILED DESCRIPTION OF THE PREFERRED EMBODIMENT

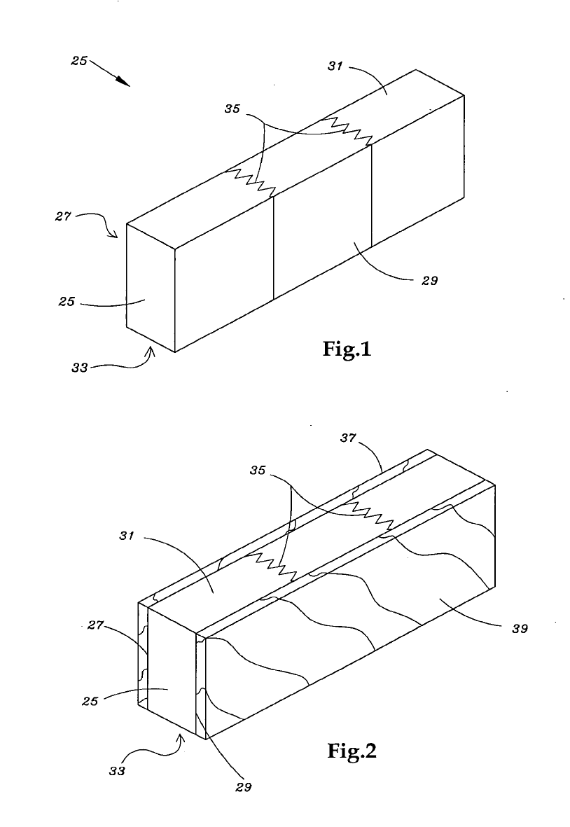

The description and operation of the slat of the present invention will begin to be best described with reference to FIG. 1, which is a perspective view of a generally rectangular support structure 25 having a first longitudinal main side surface 27 oppositely disposed from a second longitudinal main side surface 29 and a third longitudinal side surface 31 oppositely disposed from a fourth longitudinal side surface 33, each of third and fourth longitudinal side surfaces 31 and 33 extending between first and second longitudinal main side surfaces 27 and 29.

Note that while FIG. 1 illustrates support structure 25 as having multiple joints 35, implying construction from several short lengths of material such as scrap wood or other inexpensive material, support structure 25 may also be a single length of material. In a related case, U.S. patent Ser. No. 10/120,468 which matured into U.S. Pat. No. 6,763,873, a technique was described for producing finger jointed slats from single or multiple blocks wood which have been joined together laterally and had been cut with an extended fitting joint shape, with blocks being joined together by gluing at such opposing fitting joint shapes. The technique of this issued patent is incorporated by reference herein.

FIG. 2 is a perspective view of support structure 25 having a first veneer sheet 37 affixed to first longitudinal main side surface 27 and a second veneer sheet 39 affixed to second longitudinal main side surface 29 so that the support structure 25 is sandwiched between first and second veneer sheets 37 and 39. Veneer sheets 37 and 39 may be affixed to support structure 21 using any adhesive which is commonly acceptable for use in veneering applications.

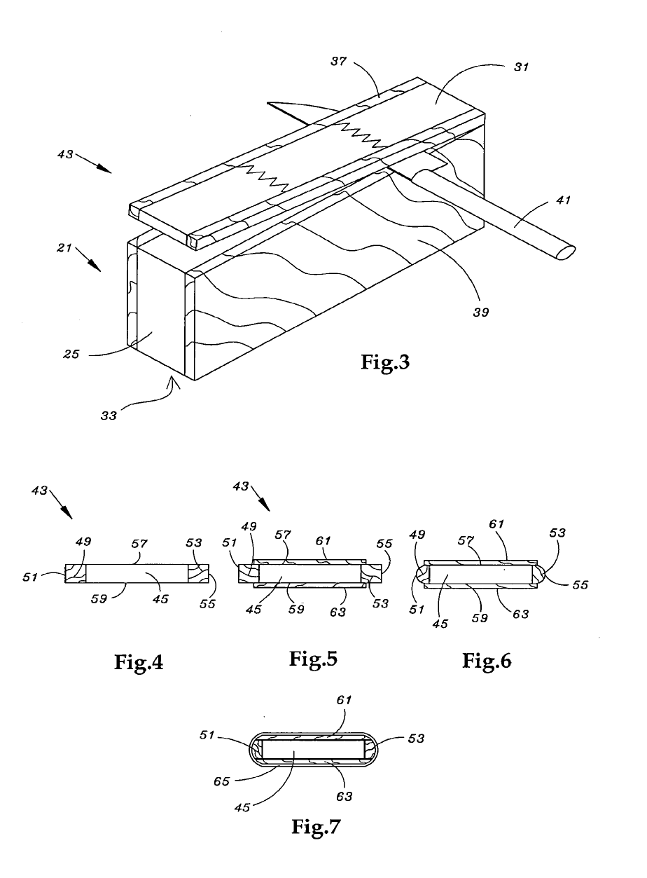

FIG. 3 is a perspective view of the veneered support structure 25 of FIG. 2, and further illustrates a cutting tool 41 (which is merely representative of any of a variety of cutting tools and which is not an element of the present invention) extending parallel to third and fourth longitudinal side surfaces 31 and 33 and through first veneer sheet 37, support structure 25, and second veneer sheet 39 to isolate a partially veneered slat 43. Typically, saw blades can obliterate several millimeters of material while making a cut. To conserve potentially expensive and scarce veneering material, the partially veneered support structure 21 may be sliced, as shown, but may also conceivably be sawn, lasered or otherwise cut to form multiple slats identical to slat 43.

FIG. 4 is a cross-sectional view of the slat 43 of FIG. 3. Slat 43 includes a support structure 45, a first veneer strip 49 which forms the first main edge 51 of slat 43, and a second veneer strip 53 oppositely disposed from first veneer strip 49 and forming the second main edge 55 of slat 43. Slat 43 further includes a first main side 57 oppositely disposed from a second main side 59.

FIG. 5 is a cross-sectional view of the slat 43 of FIG. 4 which further includes a first veneer sheet 61 affixed to first main side 57 and a second veneer sheet 63 affixed to second main side 59. Ideally, veneer sheets 61 and 63 should extend just past each of the interfaces between support structure 45 and first and second veneer strips 49 and 53, respectively. Closely controlling the overlap of veneer sheets 61 and 63 should allow support structure 45 to be sufficiently enclosed so that gaps do not form between veneer strips 49 and 53 and veneer sheets 61 and 63 upon sanding. Controlling overlap of veneer sheets 61 and 63 should also help to minimize waste upon sanding.

It should be noted that the veneer sheets 61 and 63 are shown as overlapping the veneer strips 49 and 53, but this need not be the case. Including the case where the veneer sheets 61 and 63 are applied first, the veneer strips 49 and 53 can be attached secondly, with blended finishing to be achieved by sanding and the like.

FIG. 6 is an alternative cross-sectional view of the slat 43 of FIG. 4 in which first veneer strip 49 and second veneer strip 53 have sanded to radius main edges 51 and 55 prior to the application of first and second veneer sheets 61 and 63. In this configuration, main edges 51 and 55 would need to be sanded a second time to bring first and second veneer sheets 61 and 63 in line with the radius of the pre-sanded main edges 51 and 55.

FIG. 7 is a cross-sectional view of the slat 43 fully veneered and completely sanded, including support structure 45, first and second veneer strips 49 and 53, and first and second veneer sheets 61 and 63. Note that the exterior surface formed by such wearing or sanding is a blended surface such that the interface between the veneer strips 49 and 53 and the first and second veneer sheets 61 and 63 cannot be detected. An exterior continuous blended surface is formed by such wearing or sanding of the attached components seen in either FIG. 5 or 6.

FIG. 7 also illustrates a layer of surface finish varnish 65 applied to slat 43. Varnish 65 should ideally be ultraviolet-resistant so that the color and quality of slat 43 may be preserved from the damaging effects of sunlight or moisture over time.

Note that FIGS. 4 through 7 may also represent end views of slat 43 where slat 43 has been custom-cut to a specific length, for example. Where this is the case, the visible end structures of slat 43, i.e., the support structure 45, first and second veneer strips 49 and 53, and first and second veneer sheets 61 and 63, may be painted, stained, or otherwise treated prior to applying varnish 65 to make them less visible than they would be if left untreated.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

1-17. (canceled)

18. A process for constructing a slat comprising the steps of:
providing a veneer support structure having a first and a second end, a first longitudinal side surface extending between said first and said second end, a second longitudinal side surface extending between said first and said second end and opposite said first longitudinal side surface, a third longitudinal side surface extending between said first and said second end and adjacent said first and second longitudinal side surfaces, and a fourth longitudinal side surface extending between said first and said second end and adjacent said first and second longitudinal side surfaces and opposite said third longitudinal side surface;
Attaching a first veneer sheet onto said third longitudinal side surface of said veneer support structure;
Attaching a second veneer sheet onto said fourth longitudinal side surface of said veneer support structure;
Slicing said veneer support structure generally parallel to said first longitudinal side to produce a partially veneered slat having a first main face which includes the first longitudinal side of said veneer support structure, and a second main face oppositely disposed from said first main face, with a first side surface extending between said first main face and said second main face carrying a first side structure as a portion of said first veneer sheet, and with a second side surface extending between said first main face and said second main face, and opposite said first side surface, and carrying a second side structure as a portion of said second veneer sheet;
attaching a third veneer sheet to said first main face of said partially veneered slat;
attaching a fourth veneer sheet to said second main face of said partially veneered slat;
finishing a set of outer surfaces of said first, second, third and fourth veneer sheets to form a continuous blended surface of said first, second, third and fourth veneer sheets to produce a slat.

19. The process of constructing a slat as recited in claim 18 wherein said finishing step includes finishing by wearing to form a continuous blended surface.

20. The process of constructing a slat as recited in claim 18 wherein said third and fourth veneer sheets at least partially overlap said first and second veneer sheets at the time that said third and fourth veneer sheets are attached to said partially veneered slat.

21. The process of constructing a slat as recited in claim 18, further comprising the step of annularly enveloping said slat with a sealant layer.

22. The process of constructing a slat as recited in claim 18, and wherein said veneer support structure has at least one joint from its construction from at least two short lengths of material.

23. The process of constructing a slat as recited in claim 22, and wherein said joint is a finger joint.

24. The process of constructing a slat as recited in claim 18, and wherein said veneer support structure has a plurality of joints from its construction from at least three short lengths of material.

25. The process of constructing a slat as recited in claim 24, and wherein said joint is a finger joint.
